(19) United States
(12) Patent Application Publication
(10) Pub. No.: US 2006/0002567 A1
(43) Pub. Date: Jan. 5, 2006

(54) Audio output mode setting apparatus and an audio output mode setting method

(75) Inventors: Hideyuki Yusa, Kawagoe-shi (JP); Shiro Kato, Kawagoe-shi (JP); Atsushi Makino, Kawagoe-shi (JP); Shinichi Sato, Kawagoe-shi (JP)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: PIONEER CORPORATION

(21) Appl. No.: 11/172,971

(22) Filed: Jul. 5, 2005

(30) Foreign Application Priority Data
Jul. 5, 2004 (JP) P2004-197662

(51) Int. Cl. H04R 29/00; H04R 3/00

(52) U.S. Cl. 381/58; 381/96

(57) ABSTRACT

An audio output mode setting apparatus for setting an output mode of audio signals to a plurality of speakers which are located at mutually different positions including: a detection device which detects a direction of a seat on which a listener of the audio signals which are outputted from the speakers sits; and an output mode setting device which sets up an output mode of the audio signals respectively to the speakers in response to the detected direction of the seat.

### BACKGROUND OF THE INVENTION

1. Field of the Invention

The present invention relates to a technical field of such as an audio output mode setting apparatus and method for setting an output mode of an audio signal to a plurality of speakers which are located at mutually different positions.

2. Related Art

In a conventional technique, in order to give realistic sensations or the like to listeners, a plurality of speakers are located at different positions such as a frontward left side, a frontward right side, a rearward left side, a rearward left side, and audio signals with respect to each of the speakers are outputted as an audio signal having properties such as a volume and a frequency band which are suitable for each of the positions of the speaker as disclosed in Japanese Unexamined Patent Publication No. 2002-152900.

In recent years, a so-called 5.1 channel Dolby surround sound system and a speaker system in compliance with a 6.1 channel surround sound system become to gain in popularity, and listeners can enjoy a stereoscopic and strong sound

Meanwhile, in an ordinary conventional audio device which is equipped in a vehicle, a plurality of speakers are fixedly located in positions such as a frontward left side (a driver's seat side), a frontward right side, a rearward left side, and a rearward right side.

However, in recent years, a rotary seat is located on the back side of a driver's seat of a vehicle such as a minivan and an autobus. Therefore, there occurs a problem that an listener has a sense of discomfort because the positions of the plurality of speakers remain unchanged even when the seat rotates to change its direction and thereby a positional relationship between the listener who sits on the seat of which direction and the speakers is changed (a sound field is changed).

### SUMMARY OF THE INVENTION

The present invention is provided to solve the above problem and to provide an audio output mode setting apparatus, an audio output setting method and so on which can maintain an output mode of an appropriate audio signal without giving a sense of discomfort to a listener even when the direction of the seat is changed.

According to a first aspect of the present invention, there is provided an audio output mode setting apparatus for setting an output mode of audio signals to a plurality of speakers which are located at mutually different positions comprising:

a detection device which detects a direction of a seat on which a listener of the audio signals which are outputted from the speakers sits; and

an output mode setting device which sets up an output mode of the audio signals respectively to the speakers in response to the detected direction of the seat.

According to a second aspect of the present invention, there is provided the audio output mode setting apparatus according to the preceding aspect, wherein

the output mode setting device refers to information pieces which show output modes of the audio signals which are preset for each of a plurality of directions of the seat, and sets up the output mode of the audio signals in response to the detected direction of the seat.

According to a third aspect of the present invention, there is provided the audio output mode setting apparatus according to the preceding aspects, wherein

the seat is provided so as to be rotatable around a reference plumb line of the seat, and

the detection device detects a rotational angle of the seat as the direction of the seat.

According to a fourth aspect of the present invention, there is provided the audio output mode setting apparatus according to the preceding aspects, wherein

the output mode setting device sets up the allocations of the audio signals to the speakers in response to the detected direction of the seat.

According to a fifth aspect of the present invention, there is provided the audio output mode setting apparatus according to the preceding aspects, wherein

the output mode setting device sets up an output timing of the audio signals to the speakers in response to the detected direction of the seat.

According to a sixth aspect of the present invention, there is provided the audio output mode setting apparatus according to the preceding aspects, wherein

the output mode setting device sets up an output volume of the audio signals respectively to the speakers in response to the detected direction of the seat.

According to a seventh aspect of the present invention, there is provided the audio output mode setting apparatus according to the preceding aspects, wherein the number of the seats is plural, and the seats are arranged at mutually different positions, wherein the audio output mode setting apparatus further comprising:

a designation receipt device which accepts a designation of any one of the plurality of the seats from the listener, wherein

the output mode setting device sets up the output modes of the audio signals respectively to the speakers in response to the direction of the designated seat and the detected direction of the seat.

According to an eighth aspect of the present invention, there is provided the audio output mode setting apparatus according to the preceding aspects, wherein the number of the seats is plural, and the seats are arranged at mutually different positions, wherein the audio output mode setting apparatus further comprising:

a seat setup device which sets up at least any one of the plurality of the seats on the basis of the direction of the detected seat and a preset order of priority of the seats, wherein

the output mode setting device sets up the output modes of the audio signals respectively to the speakers in response to the detected direction of the seat which is set up by the seat setup device.

According to a ninth aspect of the present invention, there is provided an audio output mode setting apparatus for setting up an output mode of audio signals to a plurality of speakers which are located at mutually different positions comprising:

a display control device which makes at least one of a plurality of mutually different output modes being the output modes of the audio signals respectively to the speakers display so as to be selectable;

a selection reception device for accepting a selection of the at least one output mode from a listener of the audio signals which are outputted from the speakers, and

an output mode setting device which sets up the output mode of the audio signals to the speakers on the basis of the selected output mode.

According to a tenth aspect of the present invention, there is provided the audio output mode setting according to the preceding claim, further comprising:

a display switching instruction reception device for receiving a display switching instruction of the output mode from the listener, wherein

the display control device sequentially switches to display one output mode among the plurality of output modes on the basis of the display switching instruction.

According to an eleventh aspect of the present invention, there is provided the audio output mode setting according to the preceding claim, wherein:

the output mode of the audio signals to the speakers includes at least one of an allocation of the audio signals to the speakers, an output timing of the audio signals to the speakers and an output volume of the audio signals to the speakers.

According to a twelfth aspect of the present invention, there is provided an audio output mode setting method for setting up an output mode of audio signals to a plurality of speakers which are located at mutually different positions comprising any one of sets of steps of:

detecting a direction of a seat on which a listener of the audio signals which are outputted from the speakers sits; and

setting up the output mode of the audio signals respectively to the speakers in response to the direction of the detected seat, or

displaying at least one of a plurality of mutually different output modes of the audio signals respectively to the speakers so as to be selectable;

accepting a selection of one of the output mode from the listener of the audio signals outputted from the speakers; and

setting up the output modes of the audio signals respectively to the speakers on the basis of the selected output mode.

According to a thirteenth aspect of the present invention, there is provided an audio output mode setting method for setting up an output mode of audio signals to a plurality of speakers which are located at mutually different positions comprising steps of:

displaying at least one of a plurality of mutually different output modes of the audio signals respectively to the speakers so as to be selectable;

accepting a selection of one of the output mode from the listener of the audio signals outputted from the speakers; and

setting up the output modes of the audio signals respectively to the speakers on the basis of the selected output mode.

According to a fourteenth aspect of the present invention, there is provided an audio output mode setting program product for detecting a direction of a seat on which a listener of the audio signals which are outputted from the speakers sits; and setting up the output mode of the audio signals respectively to the speakers in response to the direction of the detected seat.

According to a fifteenth aspect of the present invention, there is provided an audio output mode setting program product for displaying at least one of a plurality of mutually different output modes of the audio signals respectively to the speakers so as to be selectable; accepting a selection of one of the output mode from the listener of the audio signals outputted from the speakers; and setting up the output modes of the audio signals respectively to the speakers on the basis of the selected output mode.

According to a sixteen aspect of the present invention, there is provided a recording medium in which the audio output mode setting program product according to claim 14 or 15 is recorded so as to be able to read out.

### BRIEF DESCRIPTION OF THE DRAWINGS

In the accompanying drawings:

FIG. 1 shows an example of a schematic structure of an in-vehicle audio device according to the embodiment of the present invention;

FIG. 2 shows an example of an arrangement of the speakers 5a to 5d and an example of an arrangement of the seats 11a to 11d in a vehicle;

FIG. 3A to 3D show modes of the direction of a front right seat 11b;

FIG. 4 shows an example of an output mode table;

FIG. 5 schematically shows an example of an allocation setting method of audio signals of channels to each of the speakers in a digital signal processing unit 2;

FIG. 6 schematically shows an example of an allocation setting method of audio signals of channels to each of the speakers in a digital signal processing unit 2;

FIG. 7 is a flow chart, which is processed in a control unit 7, for showing a seat setting process by designating a listener;

FIG. 8 is a flow chart, which is processed in a control unit 7, for showing a seat setting process in accordance with a priority order of the seats;

FIG. 9 is a flow chart, which is processed in a control unit 7, for showing an audio output mode setting process;

FIG. 10(A) to 10(G) show an order of priority of seats;

FIG. 11A shows an output mode for showing an allocation of audio signals to each of channels to each of speakers which are displayed on a display panel of a display unit 10; and

FIG. 11B shows other output modes for showing allocations of audio signals of each of channels which are displayed on a display screen.

### DESCRIPTION OF THE PREFERRED EMBODIMENTS

Preferred embodiments of the present invention will be described in conjunction with the figures. Hereinafter, each meaning of the reference numbers in the drawings is as follows:

1: audio reproducing unit, 2: digital signal processing unit, 3: DAC, 4: AMP, 5: speaker, 6: angle detection unit, 7: control unit, 8: memory unit, 9: operation unit, 10: display unit, S: in-vehicle audio apparatus

The embodiment described below is about a case where the present invention is applied to an in-vehicle audio device.

### Embodiment 1

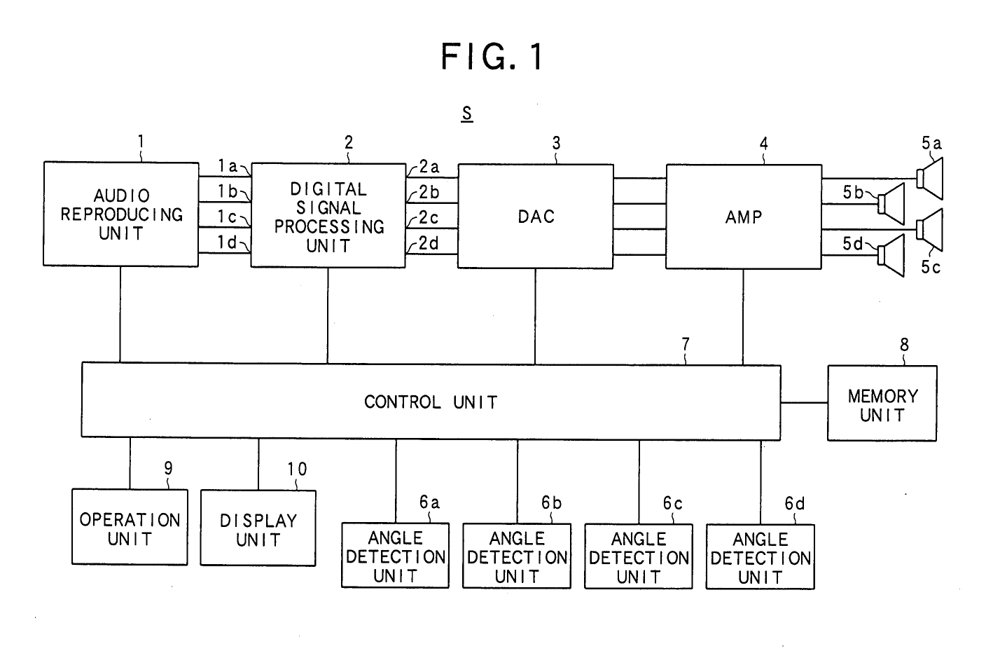

First, in reference of FIG. 1, a structure and a function of the in-vehicle audio apparatus according to the embodiment is described in reference of FIG. 1 and so on.

FIG. 1 shows a schematic structure of the in-vehicle audio apparatus according to the present embodiment.

As shown in FIG. 1, the in-vehicle audio apparatus S is made up of an audio reproducing unit 1, a digital signal processing unit 2, a digital analog converter(DAC) 3, an amplifier(AMP) 4, speakers 5a-5d, an angle detection unit 6a-6d, a control unit 7, a memory unit 8, an operation unit 9, a display unit 10, or the like.

The sound reproducing unit 1 reproduces audio data, i.e. music data, in a recording medium such as a CD, a MD, a DVD, and a memory card, which record the audio data, and outputs these as digital signals of a plurality of channels, for example a frontward left channel (FL channel), a frontward right channel (FR channel), a rearward left channel (RL channel), a rearward left channel (RL channel), and a rearward right channel (RR channel). Any thing may be adopted as the audio reproducing unit 1 as long as the audio data can be reproduced from the recording mediums in which the audio data are recorded. Meantime, the structure of such an audio reproducing unit 1 is may be a well-known structure.

The digital signal processing unit 2 is made up of a digital signal processing unit (DSP) or the like. Digital audio signals of each of the channels that are outputted from the audio reproducing unit 1 are inputted into each of input ports 1a to 1d so as to be processed with a predetermined digital signal processing. Thereafter, these digital audio signals of each of the channels are outputted from each of output ports 2a to 2d. For example, the input port 1b is a port for inputting an audio signal of the FR channel. The input port 1d is a port for inputting an audio signal of the RR channel. In the digital signal processing unit 2, the digital audio signals of each of the channels that are inputted from each of the input ports 1a to 1d are allocated the output ports 2a to 2d in response to a control signal from the contro unit 7. According to this allocation, the audio signals of each of the channels are allocated to each of the speakers 5a to 5d.

Further, in the digital signal processing unit 2, an output timing of the digital signals of each of the channels from the output ports 2a to 2d is conducted in accordance with the control signal from the control unit 7. For example, it is possible to output the digital audio signal from the output port 2d at a timing delayed by a predetermined time after an output timing of the digital audio signal from the output port 2a.

DAC 3 is provided to input the digital signals of each of the channels that are outputted from the output ports 2a to 2d of the digital signal processing unit 2 and output these signals after converting these to analog signals. AMP 4 is provided to amplify and output these analog signals.

In AMP 4, output volumes of the analog audio signals of each of the channels are conducted in accordance with a control signal from the control unit 7. For example, it is possible to set the output volume of the audio signal (sound wave) of the rearward left channel larger than the output volume of the audio signal of the rearward right channel.

The speakers 5a to 5d are located at mutually different positions in a cabin, input an analog audio signal that is outputted from AMP 4 and corresponds to the allocated channel, and outward output it as sound waves.

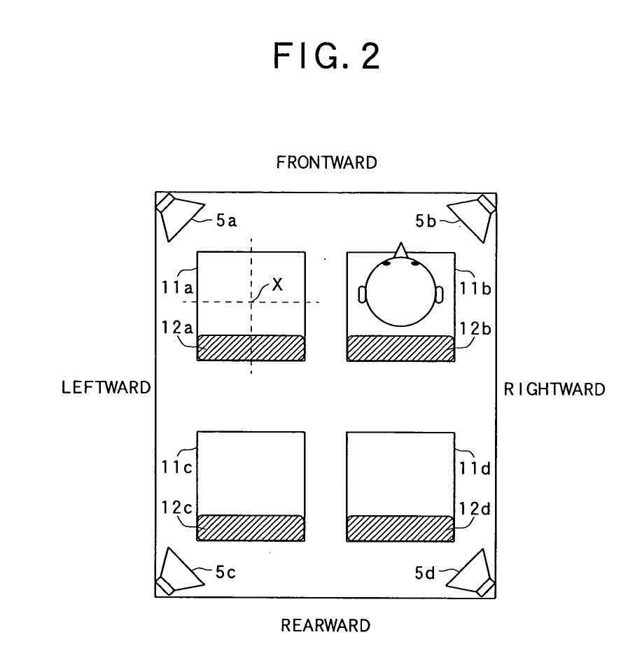

FIG. 2 shows an example of an arrangement of the speakers 5a to 5d and an example of an arrangement of the seats 11a to 11d. In the example shown in FIG. 2, provided that a side of a heading direction of a vehicle is a front, the speaker 5a is located on the frontward left side, the speaker 5b is located on the frontward right side, the speaker 5c is located on the rearward left side, and the speaker 5d is located on the rearward right side. In the example shown in FIG. 2, four seats on the back sides of a driver's seat and a co-driver's seat next to the driver's seat are shown and the driver's seat and the co-driver's seat are omitted. However, it is possible to adopt an embodiment such that frontward seats are a driver's seat and a co-driver's seat and the driver's seat and the co-driver's seat are included in six seats. In this case, the embodiment is applicable after detecting a vehicle condition from an operation of a vehicle speed pulse, application of a parking brake, or the like.

In an example shown in FIG. 2, a plurality of seats (seats where a listener of the audio signals emitted from the speakers 5a to 5d sits) are located at positions mutually different from each other. Namely, the front left seat 11a, the front right seat 11b, the rear right seat 11c, and the rear left seat 11c are located. Any of the seats 11a to 11d can be rotated around its own reference plumb line (for example, the center point X in case of seat 11a) so as to be directed toward various directions of 360 degrees.

In this, “direction of seat” designates, for example, a direction to which surfaces 12a-12d of the seat backs of the seats direct.

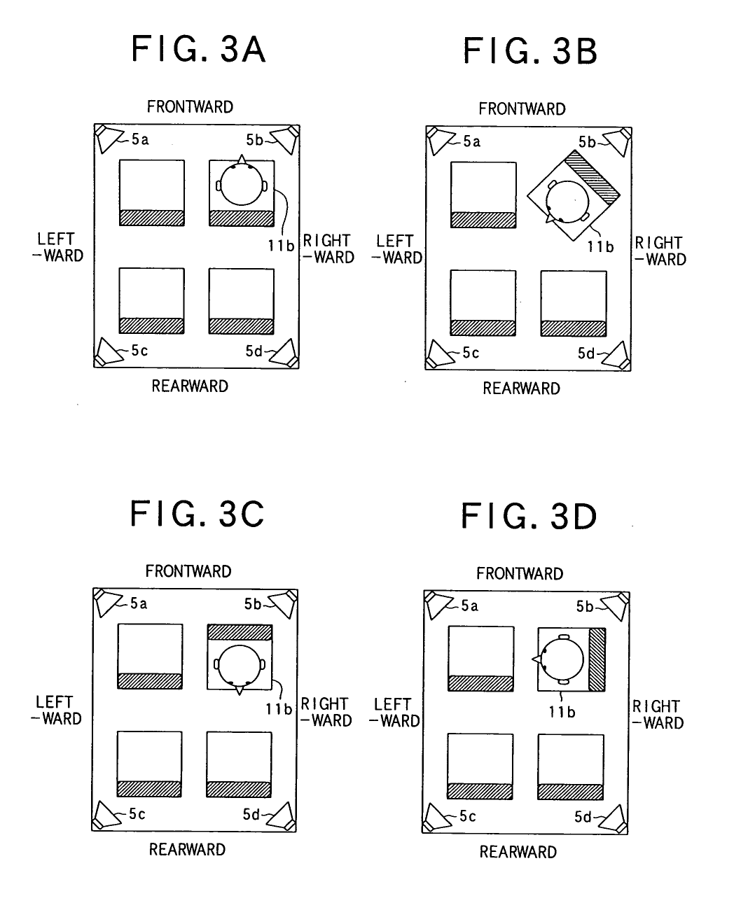

FIGS. 3A to 3D show modes of the front right seat 11b. In the example of FIG. 3A, the direction of the front right seat 11b is “FRONTWARD”, i.e. facing the front. In the example of FIG. 3B, the direction of the front right seat 11b is “LEFT REARWARD”. In the example of FIG. 3C, the direction of the front right seat 11b is “REARWARD”. In the example of FIG. 3D, the direction of the front right seat 11b is “LEFTWARD”.

Such directions of the seats can be detected upon detection of the rotary angle of the seats by the angle detection unit 6a to 6d.

The angle detection units 6a to 6d as a detection means respectively include an electrical sensor or a mechanical switch and an angle detection circuit, and located with respect to each of the seats 11a to 11d. For example, the angle detection 6a corresponds to the seat 11a. Further, in the angle detection units 6a to 6d, rotary angles of the seats are detected with respect to the frontward direction (the direction of reference axis Y) and the directions of the seats are detected on the basis of the rotary angles. For example, information showing a plurality of relationships between the ranges of the rotary angle and the directions is referred, and the direction is detected in accordance with to which range of the detected rotary angle the detected rotary angle belongs. For example, when the detected rotary angle is in the range of from 350 degree to 0 degree where the frontward direction is 0 degree or 360 degree, the direction is detected as the frontward direction. When it is in a range of from 170 degree to 190 degree, the direction is detected to be the rearward direction. Such information indicating the detected seat direction is outputted to the control unit 7 at every predetermined intervals of time.

Further, the information which indicates the rotary angle and is detected by the angle detection units 6a to 6d may outputted to the control unit 7 as a detection unit of detecting the directions of the seats based on the rotary angle.

The control unit 7 includes a CPU, a scratch pad RAM, a ROM for memorizing various data and programs, and so on. The entire component parts of an on-board audio device S are totally controlled by carious control signals. Further, the memory unit 8, the operation unit 9 and the display unit 10 are respectively connected to control unit 7.

The memory unit 8 is made up of; for example, a non-volatile memory (for example an EEPROM), a hard disk drive (HDD) or the like. For example, an output mode table to be described below is previously memorized in the memory. The operation unit 9 has an operation button for accepting various operation instructions, such as a reproduction instruction, a stop instruction, a seat designation instruction and an information display instruction from a listener or a user to output instruction signals corresponding to the various operation signals to the control unit 7. The control unit 7 conducts processes corresponding to the instruction signals. Further, the display unit 10 has a display panel, for example, a liquid crystal panel, and displays various information pieces which are indicated to display from the control unit 7 on the panel.

Further, when the CPU of the control unit 7 conducts an audio output mode setting program which is memorized in, for example, the ROM or the memory unit 8, the control unit 7 functions as an output mode setting means for setting up an output mode of the audio signal to the speakers 5a to 5d in response to the directions of the seats, i.e. the rotary angles, detected by the angle detection units 6a to 6d. For example, the control unit 7 refers to an output mode table, which is memorized in, for example, a memory unit, as information for indicating output modes of the audio signals which are previously set up for each of a plurality of directions of seat and sets up the output mode of the audio signal in response to the detected direction of seat. Further, the control unit 7 functions as a seat set-up means for setting (selecting) any one of seats which are subjected to setup of the output mode of the audio signal on the basis of the detected direction of the seat and the preset priority order of the seats.

Further, for example, at least any one of allocations of the audio signals of every channel respectively to the speakers 5a to 5d, output timings of the audio signals of every channel respectively to the speakers 5a to 5d, and output sound volumes of the audio signals of every channel respectively to the speakers 5a to 5d is included in the output mode of the audio signal.

Allocation setup of the audio signals of every channel to the speakers 5a to 5d in reference of the output mode table and in response to the detected directions of the seats will be described in detail.

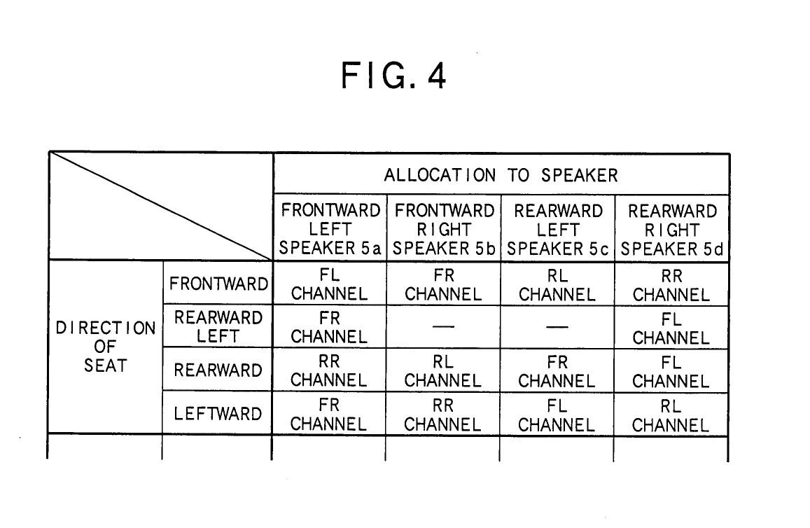

FIG. 4 shows an example of the output mode table. In the example of the output mode table shown in FIG. 4, the audio signals of the channels (the FL channel, the FR channel, the RL channel and the RR channel) are allocated to each of the various directions of the front right seat (“FRONTWARD”, “REARWARD LEFT”, “REARWARD”, and “LEFTWARD” shown in FIGS. 3A to 3D) . For example, when “FRONTWARD” is detected as the direction of the front right seat 11b, the control unit 7 supplies a control signal for respectively setting to allocate an audio signal of the RR channel to the speaker 5d (the output port 2d) on the basis of the output mode table shown in FIG. 4.

On the other hand, when “REARWARD LEFT” is detected as the direction of the front right seat 11b, the control unit 7 respectively allocates the audio signal of the FR channel to the speaker 5a (the output port 2a) and the audio signal of the FL channel to the speaker 5d (the output port 2d). A control signal for setting up so as not to allocate an audio signal of any channel to the speaker 5b (the output port 2b) and the speaker 5c (the output port 2c) is supplied to the digital signal processing unit 2. Meanwhile, the control unit 7 may be constructed so as to allocate audio signals of the RL channel and the RR channel respectively to the speaker 5b (the output port 2b) and the speaker 5c (the output port 2c) and to supply a control signal for setting up the AMP 4 to extinguish (mute) output volumes of the audio signals into the speaker 5b (the output port 2b) and the speaker 5c (the output port 2c). Further, for example, it may be possible to supply an audio signal which is obtained by subtracting between the audio signal of the FL channel and the audio signal of the FR channel into the speaker 5b (the output port 2b), and an audio signal obtained by adding the audio signal of the FL channel to the audio signal of the FR channel into the speaker 5c (the output port 2c), whereby any audio signal is outputted from the speaker 5b and the speaker 5c.

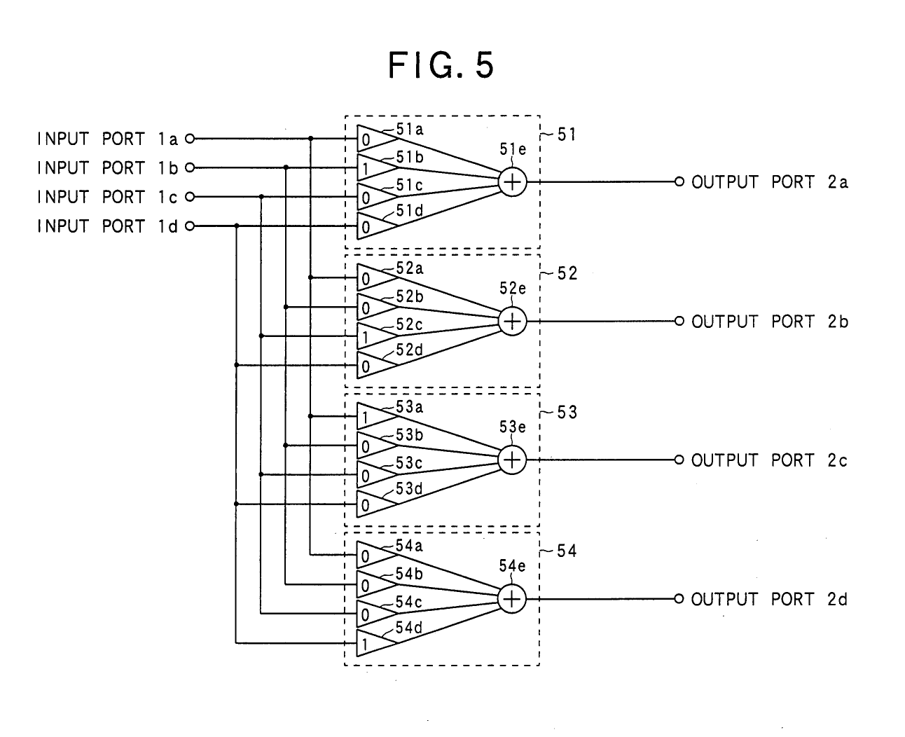

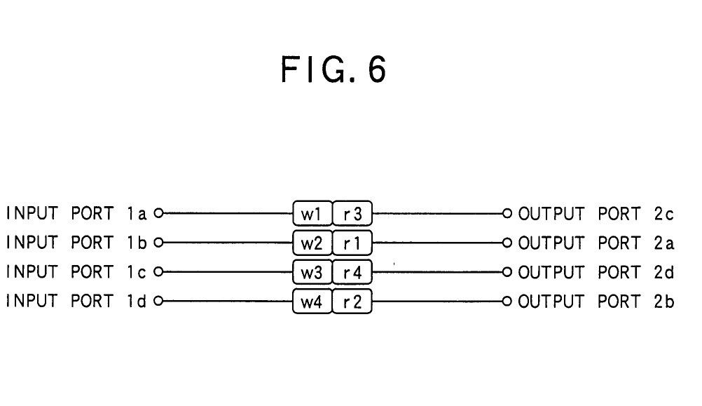

FIG. 5 and 6 are schematic views for showing a set-up example of allocating the audio signals to each channel of the speakers in the digital signal processing unit 2.

In the example shown in FIG. 5, the audio signals are set up to be allocated to each channel of the speakers by a channel set-up unit using software. In the example shown in FIG. 5, channel set-up units 51 to 54 using software are provided in the digital signal processing unit 2. Further, the output ports 2a to 2d are connected respectively to the channel set-up units 51 to 54. Further, the channel set-up units 51 to 54 respectively have four coefficient set-up switches for setting up a coefficient of “0” or “1”, e.g. coefficient set-up switches 51a to 51d in the channel set-up unit 51, and an addition unit for combining outputs from the four coefficient set-up switches, e.g. an OR logic circuit, an addition unit 51e in a channel set-up unit 51. The four coefficient set-up switches, e.g. coefficient set-up switches 51a to 51d, are respectively connected to input ports 1a to 1d. In the digital signal processing unit 2, the coefficient of “0” or “1” is set to the coefficient switch in accordance with the control signal for setting up to allocate from the control unit 7. The coefficient set-up switch to which the coefficient of “1” is set outputs an audio signal from the input port to the addition unit. The coefficient switch where the coefficient of “0” is set up does not output the audio signal from the input port to the addition unit. In the set-up example shown in FIG. 5, the direction of the front right seat 11b is in the “LEFTWARD” as shown in FIG. 3D. For example, the audio signal of the FR channel which is inputted from the input port 1b is outputted from the output port 2a through the coefficient set-up switch 51b and the addition unit 51e. Finally, it is outputted as a sound from the speaker 5a corresponding to the output port 2a. Such a coefficient of 1 or 0, which are set to the coefficient set-up switch changes in accordance with the directions of the seats. The coefficient may be a number other than 1 as long as the number is larger than 1. In this occasion, the coefficient set-up switch in which a coefficient other tan 0 is set makes the audio signal from the input port to the addition unit.

In the example shown in FIG. 6, the audio signals of each of the channels are set up to respectively allocate to the speakers in reference of a write address and a read address of a delay circuit. Specifically, a relationship between the write address of the memory to which the audio signal from the input port is written and the read address which is read out for outputting to the output port is realized in accordance with the control signal for setting to allocate from the control unit 7. The set-up example shown in FIG. 6 is about a case where the direction of the front right seat 11b is “LEFTWARD” as shown in FIG. 3D. The audio signal of the FR channel which is inputted from the input port 1b is stored in a memory of a write address w2, and thereafter read out from a memory of a read address r1, and outputted from the output port 2a. The signal is finally outputted as a sound from the speaker 5a corresponding to the output port 2a. Such a relationship between the write address and the read address is changed in accordance with the direction of the seat.

As such the audio signals of the channels allocated respectively to the speakers 5a to 5d are set up to be in an optimum state, e.g. a state where a listener can enjoy music most, in response to the directions of the seats, in other words a sitting direction of the listener.

Further, in an example shown in FIG. 4, although allocations of the audio signals of the channels respectively to the speakers 5a to 5d are shown with respect to each direction of only the front right seat 11b, allocations of the other seats 11a, 11c and 11d are similarly determined by the output mode table.

Further, in the example shown in FIG. 4, although the four directions of only the front right seat 11b, i.e: “FRONTWARD”, “REARWARD LEFT”, “REARWARD” and “LEFTWARD”, are exemplified, it is not limited thereto, and allocations of the audio signals of the channels respectively to the speakers may be determined for the other directions.

Furthermore, although in the output mode table shown in FIG. 4, only allocations of the audio signals of the channels respectively to the speakers 5a to 5d are determined, it is not limited thereto. The output timings of audio signals of the channels respectively to the speakers 5a to 5d and the output volumes of the audio signals of the channels respectively to the speakers 5a to 5d may be determined. For example, when the direction of a seat is changed from “FRONTWARD” to “LEFTWARD”, distances between the audio signals (sound waves) of identical channels and a listener is changed, for example when the direction of the seat is “FRONTWARD” the audio signal of the FL channel is transmitted from the speaker 5a, and when the direction of the seat is “LEFTWARD” the audio signal of the FL channel is transmitted from the speaker 5c. Then the output timings and output volumes of the audio signals of the channels are determined so that the a transmission delay which is caused by the distance difference to a listener or a change of volume which is sensed by a listener is corrected so as to cancel the transmission delay and the volume change.

Meanwhile, setting of the output mode of the audio signals of the channels respectively to the speakers 5a to 5d in response to a direction of which seat, i.e. setting of a seat about which output mode the audio signal is set up, is conducted by a designation through an operation unit 9 or a selection in accordance with an order of priority of the seats. This matter will be described in detail where an operation of an in-vehicle audio device S will be explained below.

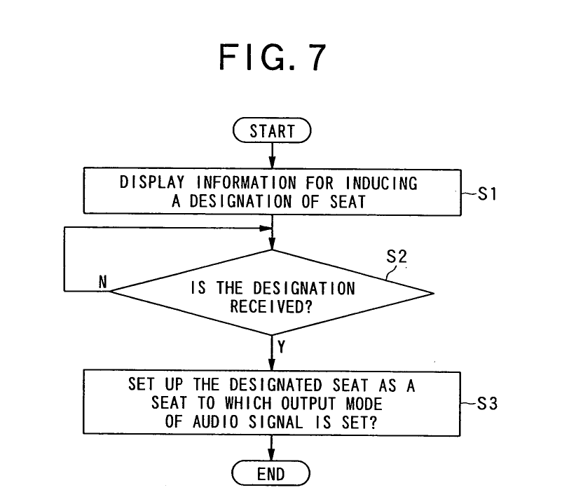

The operation of the in-vehicle audio device S according to Embodiment 1, mainly a process of the control unit 7, is described in reference of, for example, FIGS. 7. to 9.

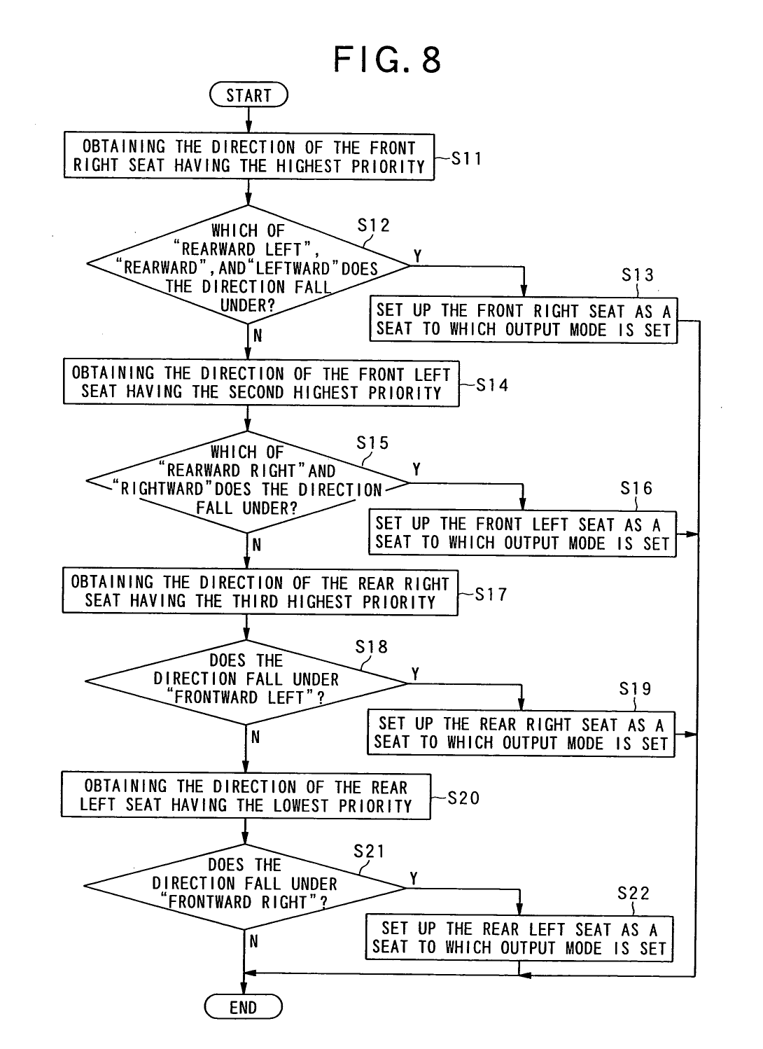

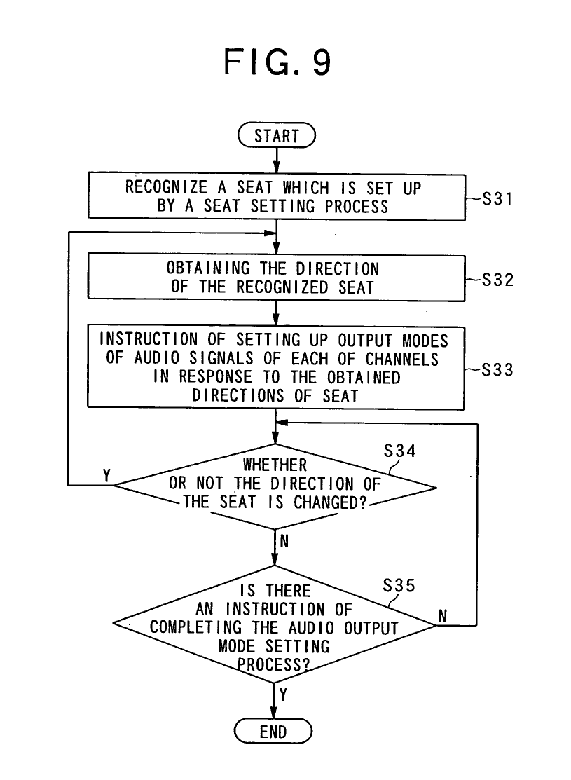

FIG. 7 is a flow chart for showing a process of setting a seat by designating a listener, which flow chart is conducted in the control unit 7. FIG. 8 is a flow chart for showing a seat setting process in accordance with the order of priority of the seats, which flow chart is conducted in the control unit 7. FIG. 9 is a flow chart for showing an audio output mode setting process, which flow chart is conducted in the control unit 7.

First, the seat setting process by designating a listener will be described in reference of FIG. 7.

When the listener pushes down an operation button corresponding to a seat which is set by designating the listener in the operation unit 9, the process shown in FIG. 7 is started, and the control unit 7 makes the display unit 10 display, for example, information designating any one of a plurality of seats 11a to 11d in Step S1.

Under this display state, when the listener operates the operation unit 9 to designate, for example, the seat where the listener sits among the plurality of the seats 11a to 11d, the control unit 7 receives the designation of the seat as a designation reception means along Y in Step S2, sets up the designated seat which is subject to the output mode of the audio signal is Step S3, and information related to the seat is memorized in the memory unit 8.

Next, in reference of FIG. 8, a seat setting process according to the order of priority of the seats will be described. In this Embodiment, the order of priority of the seats is in a sequence of the front right seat 11b, the front left seat 11a, the back right seat 11d and the back left seat 11c. Therefore, the seat setting process is conducted in accordance with this order. However, the present invention is not limited to this order.

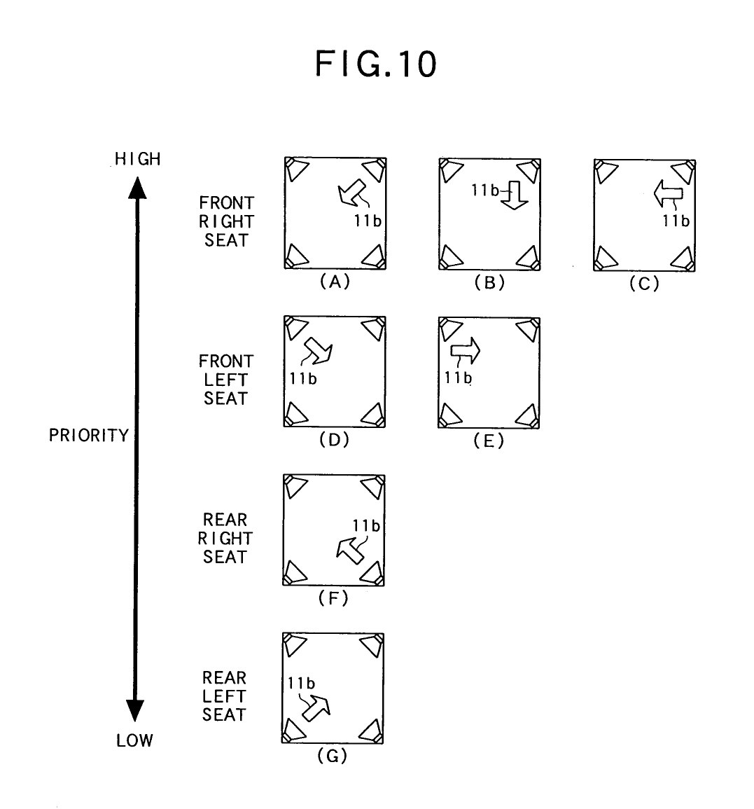

FIG. 10 shows the order of priority of the seats, and it is known that the front right seat 11b has the highest priority order.

When the listener pushes down the operation button corresponding to the seat setting according to the order of priority of the seats in the operation unit 9, the process shown in FIG. 8 starts, wherein the control unit 7 first obtains the direction of the seat that is detected by the angle detection unit 6b corresponding to the front right seat 11b of which order of priority is the highest in Step S11; judges which direction among “REARWARD LEFT” in FIG. 10A, “REARWARD” in FIG. 10B and “LEFTWARD” in FIG. 10C the direction of the front right seat 11b matches in Step S12; sets up (selects) the front right seat 11b as the seat which is subject to the output mode of the audio signals in Step S13 when the direction matches any of the above along Y in Step S12; and makes information memorize in the memory unit 8; and ends the process.

On the other hand, when the direction does not match any of the above along N in Step S12, the control unit 7 obtains the direction of the seat which is detected by the angle detection unit 6a corresponding to the front left seat 11a of the second higher order of priority in Step S14, judges in Step S15 whether or not the direction of the front left seat 11a is in any of “REARWARD RIGHT” in FIG. 10D and “RIGHTWARD” in FIG. 10E, sets up the front left seat 11a as a seat subjected to a set-up of the output mode of the audio signal in Step S16 when the direction is in any of the above directions along Y in S15, makes the memory unit 8 memorize an information piece concerning the seat, and ends this process.

On the other hand, when it does not match any of the above directions along N in Step S15, the control unit 7 obtains the direction of the seat of the third highest order of priority corresponding to the rear right seat 11d in Step S17, judges in Step S18 whether or not the direction of the rear right seat 11d is in “FRONTWARD LEFT” in FIG. 10F, sets up the rear right seat 11d as a seat subjected to a set-up of the output mode of the audio signal in Step S19 when the direction is in the above direction along Y in S18, makes the memory unit 8 memorize an information piece concerning the seat, and ends this process.

On the other hand, when it does not match the above direction along N in Step S18, the control unit 7 obtains the direction of the seat of the lowest order of priority corresponding to the rear right seat 11d in Step S20, judges in Step S21 whether or not the direction of the rear left seat 11c is in “FRONTWARD RIGHT” in FIG. 10G, sets up the rear left seat 11c as a seat subjected to a set-up of the output mode of the audio signal in Step S22 when the direction is in the above direction along Y in S21, makes the memory unit 8 memorize an information piece concerning the seat, and ends this process.

Further, it is possible to add “REARWARD” in the seat 11a, “RIGHTWARD” in the seat 11c, and “LEFTWARD” in the seat 11d respectively to the judgment.

Since the seat is set up in accordance with the order of priority of the seats, it is possible to further rapidly select the seat which is subjected to the setup because the seat is set up in accordance with the order of priority of the seats.

Next, the audio output mode setting process will be described in reference of FIG. 9.

When a listener selects an automatic setting mode of the audio output mode by operating the operation unit 9, the process shown in FIG. 9 is started, and the control unit 7 recognizes the seat which is set up by a seat set-up process shown in FIGS. 8 and 9.

Next, the control unit 7 obtains the direction of the seat which is detected by the angle detection unit, i.e. any of 6a to 6d, corresponding to the recognized seat in Step S32.

Next, the control unit 7 refers to the above mentioned output mode table to set up the output mode of the audio signals respectively of the channels in response to the direction of the obtained seat, obtains an information piece which relates to the output modes (e.g. the allocations to the speakers) of the audio signals respectively of the channels and corresponding to the directions of the seats in Step S33. By this, as explained in reference of FIGS. 5 and 6, the allocations of the audio signals of the channels respectively to the speakers 5a to 5d are set up in the digital signal processing unit 2.

Furthermore, the control unit 7 obtains the direction of the seat which is detected by the angle detection unit, i.e. any of 6a to 6d, corresponding to the seat thus recognized, judges whether or not the direction of the seat is changed, returns to Step S32 when the direction changes along Y in Step S34, and conducts the process as described above. Meanwhile, when the direction of the seat does not change along N in Step S34, it is judged whether or not it is instructed to end the audio signal output mode setting process from the listener through the control unit 9 in Step S35. When there is the instruction to end along Y in Step S35, the process ends.

As described above, since according to the above embodiment, the direction of the seat is detected and the output mode of the audio signals of the channels respectively to the speakers, for example the allocations to the speakers, are constructed to be set up, it is possible to maintain the appropriate output mode of the audio signals without giving a sense of discomfort to the listener even though the direction of the seat is changed,

### Embodiment 2

Although it is described in Embodiment 1 that the output mode of the audio signals respectively to the speakers 5a to 5d is automatically set up (the automatic setting mode of the audio output mode) in response to the direction of the detected seat, it is possible to construct to set up the output mode of the audio signals respectively to the speakers 5a to 5d in a manual setting mode of the audio output mode out of a plurality of output modes which are mutually different and are included in the output modes audio signals of the channels respectively to the speakers 5a to 5d as another example on the basis of one output mode which is selected by the listener. In this embodiment, although it is unnecessary to detect the direction of the seat, the structure as in FIG. 1 is applicable.

This transition of the manual setting mode of the audio output mode is conducted by selecting, for example, the manual mode of the audio output mode by an operation of the operation unit 9 by a listener. The control unit 7 as the display control means makes the display unit 10 display at least one of the plurality of mutually different output modes among the output modes (e.g. allocations of the audio signals of the channels respectively to the speakers) of the audio signals of the channels respectively to the speakers 5a to 5d so that the output modes are selectable.

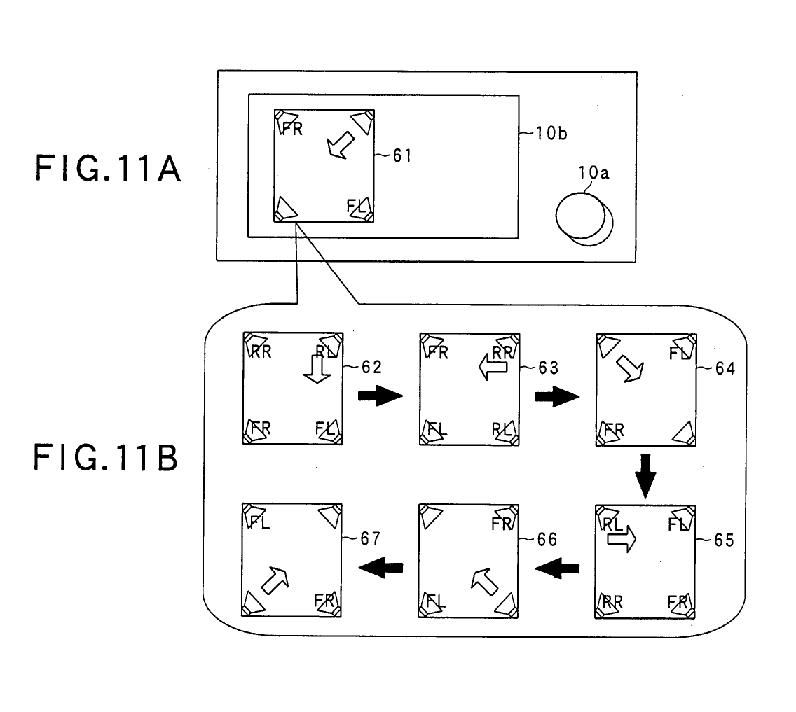

FIG. 11A shows one output mode for showing allocations of audio signals of channels respectively to speakers which are displayed on a display panel of a display unit 10. FIG. 11B shows other output modes for showing allocations of the audio signals of the channels which should be displayed on the display panel. The output modes 61 to 67 shown in FIGS. 11A and 11B respectively correspond to FIGS. 10A to 10F.

In such a display state, when the listener turns for example a toggle/rotary switch 10a of the operation unit 10, a display switching instruction (signal) of the output mode from the operation unit 10 is outputted from the operation unit 10 to the control unit 7. The control unit 7 accepts such a display switching instruction as a display switching instruction reception means, and sequentially switches and displays one output mode out of the plurality of the output modes on the basis of the display switching instruction. Accordingly, the output modes 62 to 67 are sequentially displayed in the order of the arrows shown in FIG. 11B.

When the listener selects the output mode by pushing down the toggle/rotary switch 10a in a state where the desirable output mode is displayed on the display panel, a selection (signal) of the one output mode is outputted to the control unit 7. The control unit 7 accepts the selection of the one output mode, and set up output modes (allocations) of the audio signals of the channels respectively to the speakers 5a to 5d. Such setting is conducted in reference of the output mode table as in the above embodiment.

Further, the transition to the manual setting mode of the audio output mode may be conducted for example when an event that the whole or a part of the backrest of the seats 11a to 11d is backward fall, for example the slant angle of the backrest becomes 150 degree or more by a reclining function of the seats, is detected. In this case, the angle detection units 6a to 6d are constructed to detect not only the detection of the rotation angle of the seats 11a to 11d but also the slant angles of the backrests 11a to 11d. According to Embodiment 2, the listener can rapidly set up the output mode (allocation) which is desired by the listener himself.

Further, in Embodiment 2, the control unit 7 may be constructed to detect the rotation angles of the seats 11a to 11d in receipt of a signal from the above electrical sensor or a mechanical switch in place of the angle detection units 6a to 6d.

Further, although the digital signal processing unit 2 is made up of a DSP and the output mode of the audio signals respectively to the speakers 5a to 5d is set up as the software, it may be possible to set up as a hardware in which the digital signal processing unit 2 is formed by an analogue circuit.

Further, it maybe constructed such that the above audio output mode setting program is memorized and stored in a predetermined server which is connected to a communication network including, for example, an internet and a mobile communication network including a communication base transceiver station, downloaded from the server S to the in-vehicle audio device S, or an audio output mode setting program which is recorded in a recording medium such as a CD-ROM is assembled into the in-vehicle audio device S through a drive device of the recording medium or the like.

Further, although the example that the present invention is applied to the in-vehicle audio apparatus is described, the invention is not limited thereto and applicable to, for example, an in-vehicle navigation device. Further, the setup is not limited to “in-vehicle” and the invention is applicable to an audio device which is set up in a train, an airplane or the like.

The present invention is not confined to the configurations listed in the foregoing embodiments, but it is easily understood that the person skilled in the art can modify such configurations into various other modes, within the scope of the present invention described in the claims.

The entire disclosures of Japanese Patent Applications No. 2004-197662 filed on Jul. 5, 2004 including the specification, claims, drawings and summary are incorporated herein by reference in its entirety.

What is claimed is:

1. An audio output mode setting apparatus for setting an output mode of audio signals to a plurality of speakers which are located at mutually different positions comprising:
a detection device which detects a direction of a seat on which a listener of the audio signals which are outputted from the speakers sits; and
an output mode setting device which sets up an output mode of the audio signals respectively to the speakers in response to the detected direction of the seat.

2. The audio output mode setting apparatus according to claim 1, wherein
the output mode setting device refers to information pieces which show output modes of the audio signals which are preset for each of a plurality of directions of the seat, and sets up the output mode of the audio signals in response to the detected direction of the seat.

3. The audio output mode setting apparatus according to claim 1, wherein
the seat is provided so as to be rotatable around a reference plumb line of the seat, and
the detection device detects a rotational angle of the seat as the direction of the seat.

4. The audio output mode setting apparatus according to claim 1, wherein
the output mode setting device sets up the allocations of the audio signals to the speakers in response to the detected direction of the seat.

5. The audio output mode setting apparatus according to claim 1, wherein
the output mode setting device sets up an output timing of the audio signals to the speakers in response to the detected direction of the seat.

6. The audio output mode setting apparatus according to claim 1, wherein
the output mode setting device sets up an output volume of the audio signals respectively to the speakers in response to the detected direction of the seat.

7. The audio output mode setting apparatus according to claim 1, wherein the number of the seats is plural, and the seats are arranged at mutually different positions, wherein the audio output mode setting apparatus further comprising:
a designation receipt device which accepts a designation of any one of the plurality of the seats from the listener, wherein
the output mode setting device sets up the output modes of the audio signals respectively to the speakers in response to the direction of the designated seat and the detected direction of the seat.

8. The audio output mode setting apparatus according to claim 1 wherein the number of the seats is plural, and the seats are arranged at mutually different positions, wherein the audio output mode setting apparatus further comprising:
a seat setup device which sets up at least any one of the plurality of the seats on the basis of the direction of the detected seat and a preset order of priority of the seats, wherein
the output mode setting device sets up the output modes of the audio signals respectively to the speakers in response to the detected direction of the seat which is set up by the seat setup device.

9. An audio output mode setting apparatus for setting up an output mode of audio signals to a plurality of speakers which are located at mutually different positions comprising:
a display control device which makes at least one of a plurality of mutually different output modes being the output modes of the audio signals respectively to the speakers display so as to be selectable;
a selection reception device for accepting a selection of the at least one output mode from a listener of the audio signals which are outputted from the speakers, and
an output mode setting device which sets up the output mode of the audio signals to the speakers on the basis of the selected output mode.

10. The audio output mode setting apparatus according to claim 9, further comprising:
a display switching instruction reception device for receiving a display switching instruction of the output mode from the listener, wherein
the display control device sequentially switches to display one output mode among the plurality of output modes on the basis of the display switching instruction.

11. The audio output mode setting apparatus according to claim 9, wherein
the output mode of the audio signals to the speakers includes at least one of an allocation of the audio signals to the speakers, an output timing of the audio signals to the speakers and an output volume of the audio signals to the speakers.

12. An audio output mode setting method for setting up an output mode of audio signals to a plurality of speakers which are located at mutually different positions comprising any one of sets of steps of:
detecting a direction of a seat on which a listener of the audio signals which are outputted from the speakers sits; and
setting up the output mode of the audio signals respectively to the speakers in response to the direction of the detected seat, or
displaying at least one of a plurality of mutually different output modes of the audio signals respectively to the speakers so as to be selectable;
accepting a selection of one of the output mode from the listener of the audio signals outputted from the speakers; and
setting up the output modes of the audio signals respectively to the speakers on the basis of the selected output mode.
